(19) United States
(12) Patent Application Publication
(10) Pub. No.: US 2005/0086162 A1
(43) Pub. Date: Apr. 21, 2005

(54) Debt Elimination Business Method

(75) Inventor: Kenneth Glen Titus Sr., Scotia, NY (US)

Correspondence Address: LAW OFFICE OF JAY R. YABLON, 910 NORTHUMBERLAND DRIVE, SCHENECTADY, NY, 12309-2814, US

(73) Assignee: Kenneth Glen Titus, Schenectady, NY (US)

(21) Appl. No.: 10/905,593

(22) Filed: Jan. 12, 2005

Related U.S. Application Data
(60) Provisional application No. 60/535,791, filed on Jan. 12, 2004.

(51) Int. Cl. G06F 17/60

(52) U.S. Cl. 705/40

(57) ABSTRACT

A business method for debt elimination is disclosed, comprising: a core bank depositing between $5 million and $5 billion into a core account; said core bank creating at least one financial instrument against said core account; said core bank fractionalizing said at least one financial instrument through the Fed Window; splitting 200% of the value of said at least one financial instrument equally into two separate cash accounts in the name of a business entity, in relation to receiving money from said fractionalization; placing said at least one instrument into a non-depletion account; a purchaser purchasing said at least one financial instrument in increments of at least $125 million; said core bank providing a valued safe-keeping receipt, in said increments of at least $125 million; said purchaser purchasing said at least one financial instrument from said core bank for approximately 225% of the safe-keeping receipt value; said core bank receiving a first payment of 125% of the safe-keeping receipt value of said at least one financial instrument and placing said first payment in a received payments account; said core bank receiving a final payment of 100% of the safe-keeping receipt value of said at least one financial instrument and placing said final payment in said received payments account.

### CROSS-REFERENCE TO RELATED APPLICATIONS

This application claims benefit of U.S. provisional application 60/535,791 filed Jan. 12, 2004.

### BACKGROUND OF THE INVENTION

It is desirable to develop a business method to eliminate debt for those drowning in mortgage, credit card and other types of debt.

What is needed is a novel and non-obvious business method, utilizing recognized and legal banking practices, to provide the necessary funds to accomplish this objective.

### SUMMARY OF THE INVENTION

Disclosed herein is a business method for debt elimination, comprising: a core bank depositing between $5 million and $5 billion into a core account; said core bank creating at least one financial instrument against said core account; said core bank fractionalizing said at least one financial instrument through the Fed Window; splitting 200% of the value of said at least one financial instrument equally into two separate cash accounts in the name of a business entity, in relation to receiving money from said fractionalization; placing said at least one instrument into a non-depletion account; a purchaser purchasing said at least one financial instrument in increments of at least $125 million; said core bank providing a valued safe-keeping receipt, in said increments of at least $125 million; said purchaser purchasing said at least one financial instrument from said core bank for approximately 225% of the safe-keeping receipt value; said core bank receiving a first payment of 125% of the safe-keeping receipt value of said at least one financial instrument and placing said first payment in a received payments account; said core bank receiving a final payment of 100% of the safe-keeping receipt value of said at least one financial instrument and placing said final payment in said received payments account; said business entity purchasing said at least one financial instrument and transferring said at least one financial instrument to a beneficiary of said business entity; and said beneficiary retiring said at least one financial instrument.

### BRIEF DESCRIPTION OF THE DRAWINGS

The features of the invention believed to be novel are set forth in the appended claims. The invention, however, together with further objects and advantages thereof, may best be understood by reference to the following description taken in conjunction with the accompanying drawing(s) in which:

FIG. 1 is flow chart illustrating a preferred method of this invention.

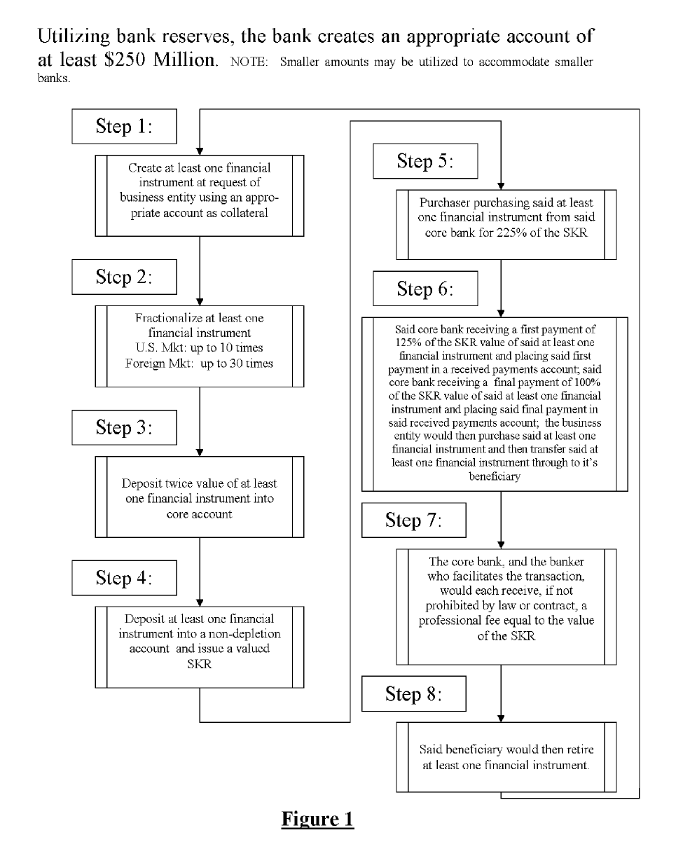

FIG. 2 is a chart showing an illustrative example of the use of this method.

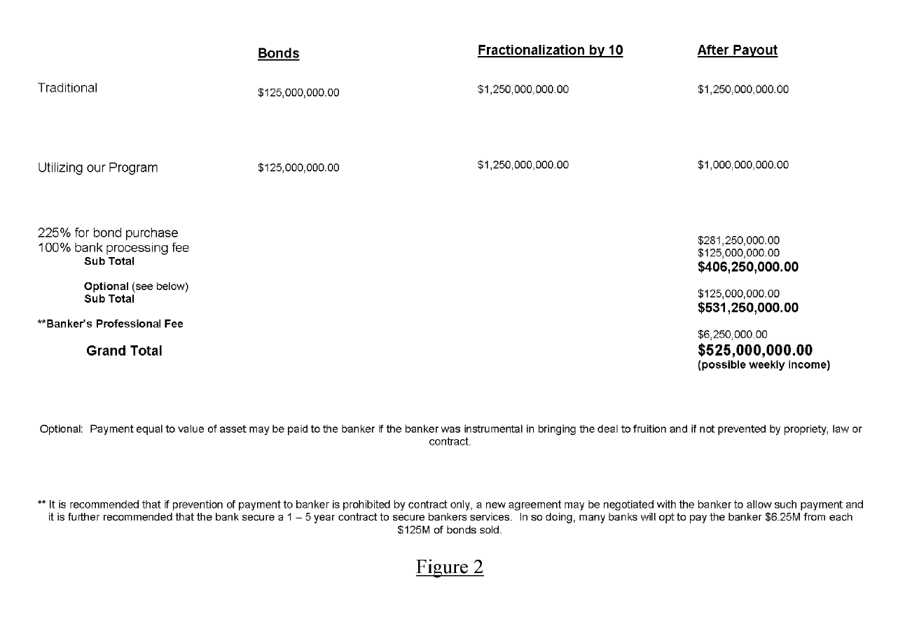

Together, these Figures map the accounts, the flow of funds and the placement of instruments as disclosed herein.

### DETAILED DESCRIPTION

A core bank deposits between $5 million and $5 billion into an appropriate account which would be used as the core account for this purpose.

Against the core account, the core bank creates a bond or any other financial instrument(s) that the bank deems appropriate based upon the request of a business entity. The core bank fractionalizes the instrument(s) through the Fed Window. Each fractionalized instrument is between $5 million and $5 billion. This amount is determined according to the desires of the loaning bank. Preferably, for 5 to 6 instrument(s), the total accumulates to $125 million or more.

As money is received from the fractionalization of the financial instrument(s), 200% of the value of the financial instrument(s) is split equally into two separate cash accounts in the name of the business entity.

The instrument(s) are then be placed into a non-depletion account. A purchaser purchases the financial instrument(s) in increments of at least $125 million.

The core bank provides a valued safe-keeping receipt, in said increments of at least $125 million, reflecting the value of the instrument(s).

The purchaser purchases the instrument(s) from the core bank for approximately 225% of the safe-keeping receipt value. This purchase process preferably includes a contract between the purchaser and the core bank, followed by an irrevocable letter of instruction.

A core bank representative and the purchaser are signatories to the non-depletion account.

With the account secure and the contract including letter of instructions signed off by core bank representative and the purchaser, the transaction commences within a brief transaction commencement period of time (preferably, but not limited to 2 to 3 weeks). A first payment of 125% of the safe-keeping receipt value of the financial instrument(s) is received by the core bank to be placed in a received payments account. A brief final payment time thereafter (preferably, but not limited to, about three weeks) a final payment of 100% of the safe-keeping receipt value of the instrument(s) is paid into the same received payments account.

At this stage the core bank has received full payment and the financial instrument(s) is/are turned over to the purchaser or remains in the account at the purchaser's option. The core bank retains all monies received, as per contract.

The business entity then purchases the financial instrument(s) and transfers the financial instrument(s) through to it's beneficiary. Said beneficiary then retires the financial instrument(s).

Also, as part of this process, the core bank, and the banker who facilitates the transaction would each receive, if not prohibited by law or contract, a professional fee equal to the value of the safe-keeping receipt, as closely as possible following said 100% final payment.

The process can be repeated by creating an instrument(s) upon instructions from business entity as to the amount that is needed to clear specific documented debt.

Business entity should have the means to transfer funds either by check, electronic transfer or any other method.

Repurchase of the instrument(s) may also be achieved through business entity without the use of the 225% of the safe-keeping receipt value step. In that case, business entity purchases the instrument(s) at 100% of their face value from a purchase account established for business entity by the core bank, which is one of the two cash accounts established for the business entity by the core bank.

While only certain preferred features of the invention have been illustrated and described, many modifications and changes will occur to those skilled in the art. It is, therefore, to be understood that the appended claims are intended to cover all such modifications and changes as fall within the true spirit of the invention.

1. A business method for debt elimination, comprising:
a core bank depositing between $5 million and $5 billion into a core account;
said core bank creating at least one financial instrument against said core account;
said core bank fractionalizing said at least one financial instrument through the Fed Window;
splitting 200% of the value of said at least one financial instrument equally into two separate cash accounts in the name of a business entity, in relation to receiving money from said fractionalization;
placing said at least one instrument into a non-depletion account;
a purchaser purchasing said at least one financial instrument in increments of at least $125 million;
said core bank providing a valued safe-keeping receipt, in said increments of at least $125 million;
said purchaser purchasing said at least one financial instrument from said core bank for approximately 225% of the safe-keeping receipt value;
said core bank receiving a first payment of 125% of the safe-keeping receipt value of said at least one financial instrument and placing said first payment in a received payments account;
said core bank receiving a final payment of 100% of the safe-keeping receipt value of said at least one financial instrument and placing said final payment in said received payments account;
said business entity purchasing said at least one financial instrument and transferring said at least one financial instrument to a beneficiary of said business entity; and
said beneficiary retiring said at least one financial instrument.

2. The business method of, said at least one financial instrument comprising at least one bond.

3. The business method of, wherein each of the fractionalized financial instruments is between $5 million and $5 billion.

4. The business method of, wherein a total of said fractionalized financial instruments is at least $125 million.

5. The business method of, said purchaser purchasing comprising signing a contract between said purchaser and said core bank, followed by an irrevocable letter of instruction.

6. The business method of, further comprising, after said receiving said final payment, turning said at least one financial instrument over to said purchaser.

7. The business method of, further comprising, after said receiving said final payment, retaining said at least one financial instrument on account on behalf of said purchaser if requested by said purchaser.

8. The business method of, further comprising said core bank and a banker facilitating said method each receiving a professional fee equal to said safe-keeping receipt value.

9. A business method for debt elimination, comprising:
a core bank depositing between $5 million and $5 billion into a core account;
said core bank creating at least one financial instrument against said core account;
said core bank fractionalizing said at least one financial instrument through the Fed Window;
splitting 200% of the value of said at least one financial instrument equally into two separate cash accounts in the name of a business entity, in relation to receiving money from said fractionalization;
placing said at least one instrument into a non-depletion account;
a purchaser purchasing said at least one financial instrument in increments of at least $125 million;
said core bank providing a valued safe-keeping receipt, in said increments of at least $125 million;
said business entity purchasing said at least one financial instrument at 100% of their face value from a purchase account established for business entity by said core bank;
transferring said at least one financial instrument to a beneficiary of said business entity; and
said beneficiary retiring said at least one financial instrument.

10. The business method of, said at least one financial instrument comprising at least one bond.

11. The business method of, wherein each of the fractionalized financial instruments is between $5 million and $5 billion.

12. The business method of, wherein a total of said fractionalized financial instruments is at least $125 million.

13. The business method of, said purchaser purchasing comprising signing a contract between said purchaser and said core bank, followed by an irrevocable letter of instruction.

14. The business method of, further comprising, after said receiving said final payment, turning said at least one financial instrument over to said purchaser.

15. The business method of, further comprising, after said receiving said final payment, retaining said at least one financial instrument on account on behalf of said purchaser if requested by said purchaser.

16. The business method of, further comprising said core bank and a banker facilitating said method each receiving a professional fee equal to said safe-keeping receipt value.
